(19) United States
(12) Patent Application Publication
(10) Pub. No.: US 2014/0067548 A1
(43) Pub. Date: Mar. 6, 2014

(54) SAVING ON DEVICE FUNCTIONALITY FOR BUSINESS CALENDAR

(71) Applicants: Xuebo Liang, Brossard (CA); Rolan Abdukalykov, Montreal (CA); Edward Palmer, Westmount (CA); Alain Gauthier, Montreal (CA); Roy Ghorayeb, Montreal (CA); Mohannad El-Jayousi, L'Ile-Bizard (CA); Vincent Lavoie, Montreal (CA)

(72) Inventors: Xuebo Liang, Brossard (CA); Rolan Abdukalykov, Montreal (CA); Edward Palmer, Westmount (CA); Alain Gauthier, Montreal (CA); Roy Ghorayeb, Montreal (CA); Mohannad El-Jayousi, L'Ile-Bizard (CA); Vincent Lavoie, Montreal (CA)

(73) Assignee: SAP AG, Walldorf (DE)

(21) Appl. No.: 13/600,655

(22) Filed: Aug. 31, 2012

(51) Int. Cl. G06Q 30/02

(52) U.S. Cl. 705/14.68

(57) ABSTRACT

A system and method are described herein that provide for saving retrieved business objects locally in a calendar application of a local device for access during an offline mode. Business objects may be retrieved from the backend system, whereupon a plurality of actions are performed upon the retrieved business objects, such as performing searches or viewing related analytics. Detail information about the business objects, such as business object attributes and corresponding analytics are stored locally in the memory of the mobile device running the application. This is enabled by a save feature which triggers the downloading of all related information from a backend system and saving locally on the mobile device. A user may subsequently access the saved business data in environments where there is no online connectivity.

### BACKGROUND INFORMATION

Business software such as enterprise resource planning software implements business processes by modeling business data as business objects with data exchange between the objects. The business data provided via the business objects can be accessed through mechanisms such as graphical user interfaces, forms, and analytical reports. Traditionally, user interfaces providing access to business objects conveyed limited information about the attributes associated with the business objects. User interface that provide a calendar interface have presently been limited in their implementation.

Existing enterprise software applications may include a calendar to view business objects and/or calendar entries. However, these applications require a connection to a backend system every time the software application starts to retrieve business objects from the backend system. This is inefficient as it requires a prerequisite allotment of time for the business objects to be retrieved. It is also problematic because it requires a functional connection between the device running the application and the backend system which may not always be available to a user. The existing applications that provide offline connectivity have largely been focused on creating an actual separate offline application from an online application that imports data directly from the online application.

Thus, there remains a need in the art for a system for accessing business objects stored in a backend system even when no online connectivity is present within the scope of the single online configured application. There also remains a need in the art to store business objects locally on a device for access when no connectivity to a backend system is available without synchronizing between online and offline data.

### SUMMARY

A system and method are described herein that provide for storing business objects retrieved from a backend system on a local device for access using an offline mode. Business objects may be retrieved from the backend system, whereupon a plurality of actions may be performed upon the retrieved business objects, such as performing searches or viewing related analytics. Charts or timeline interfaces in which the business objects are displayed may be stored locally in the memory storage of a mobile device running the application. Detail information about the business objects, such as business object attributes and corresponding analytics, may also be stored locally in the memory of the mobile device running the application. This may be enabled by a save feature which may trigger the downloading of all related information from a backend system and saving locally on the mobile device. A user may subsequently access the saved business data in environments where there is no online connectivity.

In particular, the exemplary embodiments and/or exemplary methods are directed to a system and method for saving retrieved business objects locally in a calendar application. The system and method may include retrieving the business objects and related business data stored from a backend system, such as a server, and saving the business objects and the related business data in a memory housed in the mobile device. The business objects and related business data can later be accessed from the memory for display in a user interface of the mobile device during offline connectivity, when no network connection to a backend system is possible.

A download of the business objects and the related business data can be enabled by the triggering of the save function of the calendar application. When the saved data is retrieved during an offline mode, a timeline interface including the specific accessed business objects and related business data may be loaded in the user interface. Retrieval of the business objects and related business data from the memory may be done by a processor housed in the mobile device.

The related business data may include business object attributes and analytics of the business objects. In addition to the business objects attributes and analytics, time interfaces, search criteria, and search results in the calendar application performed by a search function, can also be stored in the memory.

In one example embodiment, all the business objects and related business data in the calendar application can be downloaded and stored in the memory. In another example embodiment, only a subset business objects and related business data pertaining to a particular timeline interface can be downloaded and stored in the memory.

### BRIEF DESCRIPTION OF THE DRAWINGS

FIG. 1 is a diagram of architecture of the system for retrieving the business objects from a backend system and saving the business data locally in a mobile device according to an embodiment.

FIG. 2 is a diagram of a graphical user interface that displays the retrieved business objects from the backend system on a mobile device according to an embodiment.

FIG. 3 is a diagram of the graphical user interface enabling a local save function for local storage on a mobile device according to an embodiment.

FIG. 4 is a diagram of a detail information window about a business object that is accessed in an offline mode according to an embodiment.

### DETAILED DESCRIPTION

The subject matter will now be described in detail for specific preferred embodiments, it being understood that these embodiments are intended only as illustrative examples and is not to be limited thereto these embodiments.

Embodiments may discuss a system and method for storing business objects retrieved from a backend system on a local device for access using an offline mode. Business objects may be retrieved from the backend system, whereupon a plurality of actions may be performed upon the retrieved business objects, such as performing searches or viewing related analytics. In an embodiment, charts or timeline interfaces in which the business objects are displayed may be stored locally in the memory storage of a mobile device running the application. Detail information about the business objects, such as business object attributes and corresponding analytics, may also be stored locally in the memory of the mobile device running the application. This may be enabled by a save feature which may trigger the downloading of all related information from a backend system and saving locally on the mobile device. A user may subsequently access the saved business data in environments where there is no online connectivity.

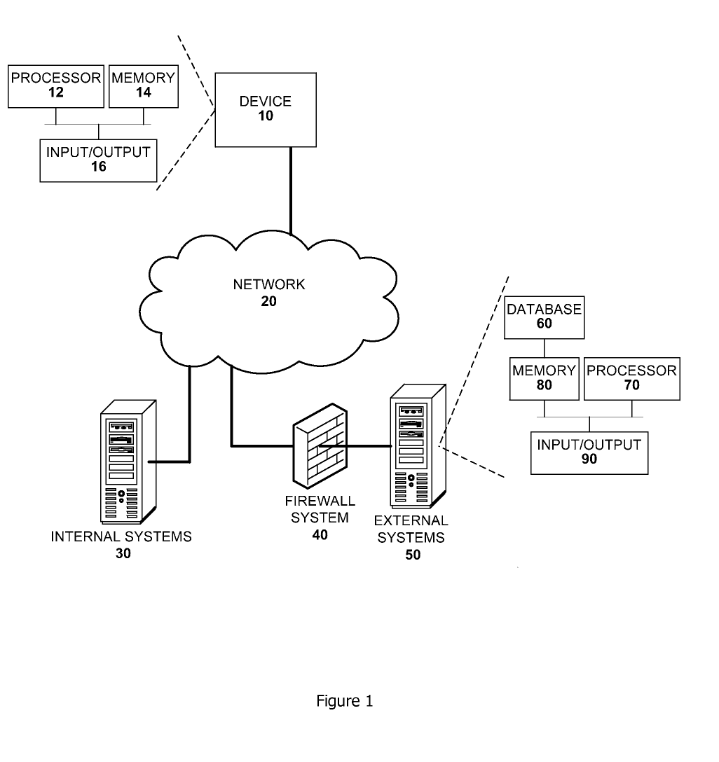

FIG. 1 illustrates an architecture of the system for retrieving the business objects from a backend system and saving the business data locally in a mobile device according to an embodiment. In an embodiment, device 10 may be a hand-held device, personal digital assistant (PDA), television set-top Internet appliance, mobile telephone, smart phone, tablet, Android™ device, iPod™, iPhone™, iPad™, etc., or as a combination of one or more thereof, or other comparable device. A mobile application, such as for example, a calendar application, may be executed on device 10. This mobile application may be displayed in a user interface that is displayed on a screen of the device 10.

Business objects may be retrieved from backend computer systems or networks to retrieve new or updated business objects. In an embodiment, the business objects may be stored as metadata in one or more database in the backend system. When the business objects are retrieved, the objects may be translated to a data protocol by a gateway that may be part of a firewall system 40. Device 10 may connect to a gateway through a platform that provides a secured connection for connectivity.

The backend systems storing the business objects may be separated into internal backend systems and external backend systems. Device 10 may connect to internal backend systems 30 through a network 20. Device 10 may also connect to external backend systems 50 through the network 20 and a firewall system 40. The firewall system 40 may include a gateway and a platform such as, for example, Sybase, to translate the business objects to a data protocol and provide a secured connection.

The existing internal backend systems 30 may include a server and may provide business data, including the business objects. The external backend systems 50 may include a server and may be maintained by a third party, such as an information service provider, and may contain business data, including the business objects, that may be updated by the third party on a periodic basis. The application on device 10 may interact with these external systems to obtain updates and new business objects, through a firewall system 40 separating the internal systems from the external systems. The gateway and platform provided by the firewall system 40 may allow for a secure transmission of the business objects and other data to device 10.

Device 10 may include a processor 12, a memory 14, and input/output interface 16. Memory 14 may have a designated storage capacity that may allow for the storage of the business object attributes and corresponding analytics of the business objects, when a local save function is enable. When a user accesses the locally saved business data, processer 12 may retrieve the data from memory 14. In an embodiment, memory 14 may contain different components for retrieving, presenting, changing, and saving the local data. Memory 14 may include a variety of memory devices, for example, Dynamic Random Access Memory (DRAM), Static RAM (SRAM), flash memory, cache memory, and other memory devices. In an embodiment, memory 14 may be a memory device that may be easily incorporated in a mobile device.

The backend systems 30 and 50 may both contain a processor 70, memory 80, a database 60, and an input/output interface 90, all of which may be interconnected via a system bus. In various embodiments, both of the systems 30 and 50 may have an architecture with modular hardware or software systems that include additional systems communicating through one or more networks. The modular design may enable a business to add, exchange, and upgrade systems, including using systems from different vendors in some embodiments. The architecture may include embodiments that have different configurations than the example embodiment depicted in FIG. 1.

In an embodiment, memory 80 may contain different components for retrieving, presenting, changing, and saving data. Memory 80 may include a variety of memory devices, for example, Dynamic Random Access Memory (DRAM), Static RAM (SRAM), flash memory, cache memory, and other memory devices. Additionally, for example, memory 80 and processor 70 may be distributed across several different computers that collectively comprise a system.

Database 60 may include any type of data storage adapted to searching and retrieval. The database 60 may include any SAP specific database such as HANA, which may be an in-memory database, or other database systems such as Informix, Oracle, DB2, or Sybase. The databases of internal backend systems 30 and external backend system 50 may store business objects for retrieval by the application executed on device 10.

Processor 70 may perform computation and control functions of a system and comprises a suitable central processing unit. Processor 70 may comprise a single integrated circuit, such as a microprocessor, or may comprise any suitable number of integrated circuit devices or circuit boards working in cooperation to accomplish the functions of a processor. Processor 70 may execute computer programs, such as object-oriented computer programs, within memory 80.

The business objects for the calendar entries may be retrieved from the databases 60 of the internal backend systems 30 and the external backend systems 50 and rendered in the calendar application executed in device 10. The business objects may represent a modeling of a particular business process of the enterprise resource planning software system. In an embodiment where there is an internal backend system, the business objects corresponding to the business processes may also be stored in a database of the internal backend system 30 in addition to the external backend system 50. In an alternate embodiment, there may be no internal backend system, and the system may only include a single backend system, external backend system 50. In this embodiment, the business objects corresponding to the business processes may be stored and retrieved from a database of the external backend system 50, to be rendered in the application and displayed in a user interface of device 10.

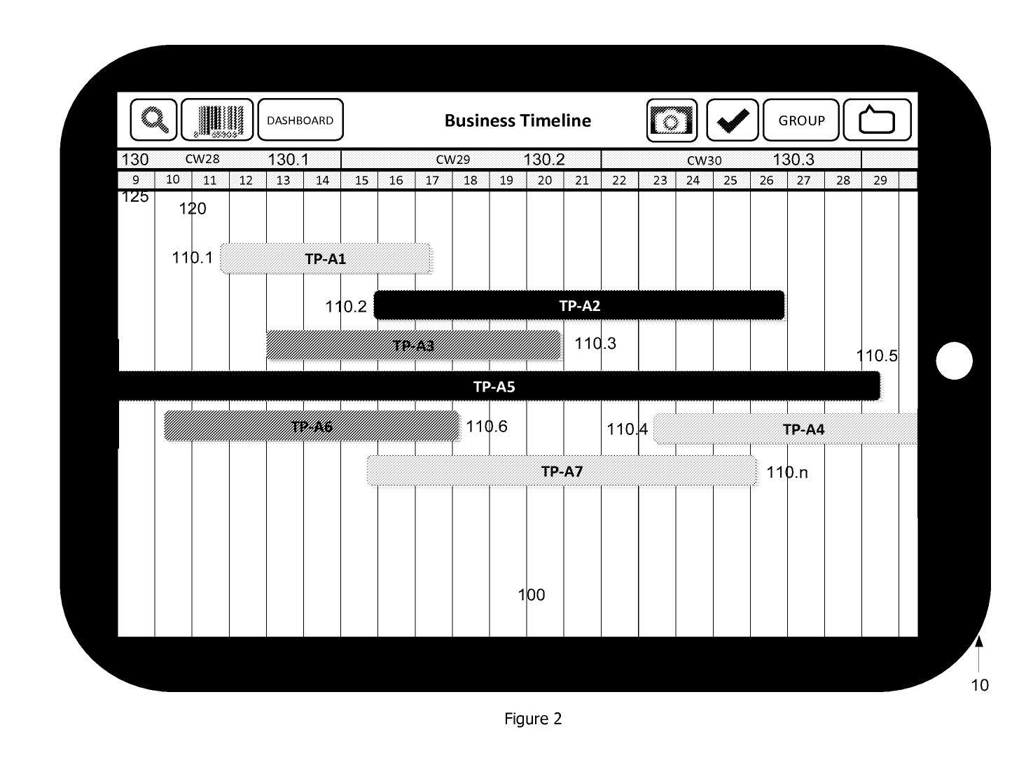

The retrieved business objects from the backend systems may be rendered in the application on device 10. Visual representation of the retrieved business objects may be dynamically created for display in the application. Visual representations associated with the business objects may be displayed on the user interface 100 of device 10 as visual bars. FIG. 2 illustrates a graphical user interface 100 that displays the retrieved business objects from the backend system on device 10 according to an embodiment.

Each visual bar may present information about a dynamically rendered business object in a corresponding detail box. In the example embodiment of FIG. 2, visual bars 110.1-110.n may be displayed on user interface 100, in a calendar interface. The number of visual bars may correspond to the number of business objects, as each visual bar may map to a specific business object of the business enterprise software.

The information in visual bars 110.1-110.n may represent business objects of the business enterprise software. The business objects being displayed in visual bars 110.1-110.n may represent a modeling of a particular business process. In an example embodiment, the visual bars 110.1-110.n may correspond to information related to projects, tasks, meeting requests, activities, campaigns, products, business promotions, sales orders, sales quotes, customer quotes, service documents and business opportunities, etc. Each of the business objects and objects represented by a corresponding visual bar may include attributes which define metadata associated with the business object. Attributes may include, for example, a specified time period, a specified product, customer information, etc. In an example embodiment where the business object corresponds to a business promotion, attributes of the business object may include the promotion period of the promotion, including a start and end date, the companies offering the promotion and the companies being offered the promotion, and the product for which the promotion applies.

The attributes of business objects displayed user interface 100 may indicate a range of values. For example, in an embodiment where the business objects correspond to business promotions, each of the business objects in visual bars 110.1-110.n may include one or more attributes indicating the time period for which the business promotion is valid. The time period may be implemented by either defining a single time period attribute associated with the business object or by defining a start date attribute and an end date attribute associated with the business object. In an alternate embodiment, the business object may include one or more attributes indicating a range of quantities to which the business promotion applies to.

The size of the visual bars 110.1-110.n in user interface 100 may be increased or decreased relative based on a selection by a user of the displayed time interval scales of the calendar application. In an embodiment, multiple displayed time interval ranges 125 and 130.1-130.2 may be displayed in user interface 100. The displayed time intervals may represent a range of values associated with at least one business object attribute. The visual bars may be positioned in the calendar application relative to the size of the displayed time intervals of the horizontal axis. In an embodiment, a first selection for a time interval scale may be made for displayed range 125. In the example embodiment in FIG. 2, range 125 may be selected to correspond to a daily time period. In this embodiment, the entries in time range 125 may correspond to subsequent days in the overall business timeline of the application. In alternate embodiments, the time interval scale for range 125 may be selected to correspond to a weekly, monthly, bi-monthly, quarterly, bi-annually, or annual scale.

Similarly, a selection may be made for the time interval scale for displayed range 130. In the example embodiment in FIG. 2, range 130 may be selected to correspond to a weekly time period. In this embodiment, the entries in time range 130 may correspond to subsequent weeks in the overall business timeline of the application. Each entry 130.1-130.3 in range 130 may map to a subset of range 125. For example, in the example embodiment of FIG. 2, days 15 to 21 in range 125 may correspond to calendar week 29 of entry 130.2. In alternate embodiments, the time interval scale for range 130 may be selected to correspond to a monthly, bi-monthly, quarterly, bi-annually, annual, or period of multiple years.

The size of visual bars 110.1-110.n may change dependent on the selection of the time interval scales for ranges 125 and 130. In an embodiment where range 125 is selected to correspond to a daily time period, visual bars 110.1-110.n may increase in size. In an embodiment where range 125 is selected to correspond to a weekly, monthly, bi-monthly, quarterly, bi-annually, or annual scale, the size of visual bars 110.1-110.n may decrease. The size of visual bars 110.1-110.n may decrease as larger time periods are selected.

The visual bars 110.1-110.n visualized in the user interface may be positioned relative to the displayed time intervals. The business objects associated with each visual representation may include business object attribute values in common with other business objects visually that are also visualized in the user interface 100.

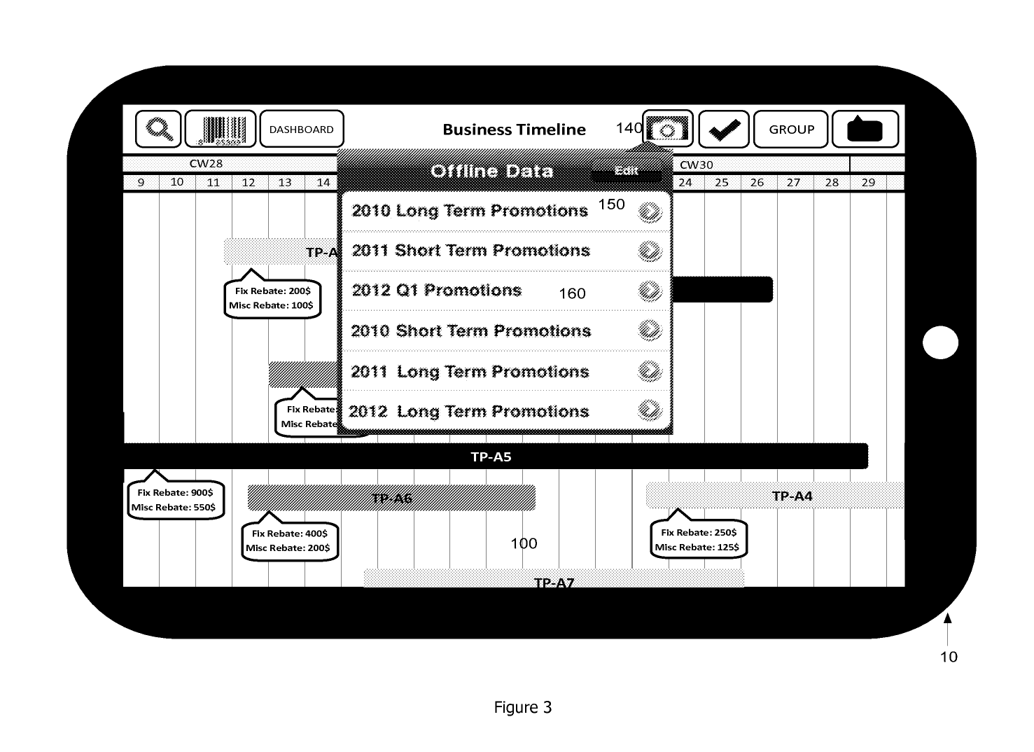

FIG. 3 illustrates the graphical user interface 100 enabling a local save function for local storage on device 10 according to an embodiment. User interface 100 may include a button 140 which may allow for triggering of the local save function of the application. In an embodiment, when a user is connected to a backend server, such as external backend system 50, a selection of button 140 may trigger a download of the business data pertaining to the business objects displayed in interface 100. In another embodiment, during online connectivity, a selection of button 140 may trigger a download of the business data pertaining to all business objects available to the application in device 10. Selection of button 140 may be made by touching button 140 with the user's finger, if device 10 has a touch screen, or in other devices, by clicking on the button with a mouse, keyboard, keypad, trackball, etc.

When the local save function is triggered, the business data related to the corresponding business objects may be saved in memory 14 of the device 10. Business data that may be saved in memory 14, may include, for examples, charts such as the embodiment depicted in the user interface of FIG. 2, where visual bars 110.1-110.n may be displayed. This particular timeline or chart may be saved in memory 14, along with the corresponding information and attribute values of the business objects represented by visual bars 110.1-110.n. Other examples of business data that may be saved in memory 14 include any search or query results performed in the user interface. Detail information about each business object in the application, including business object attributes and corresponding analytics, may also be saved in the memory 14.

Information that is saved locally via button 140 may be subsequently accessed by a user when no online connectivity is available. This may occur in instances, for example, when no network is available or the user does not have access to any of the available networks. Accessed local data may be retrieved by processor 12 from the memory 14. A user may access the saved local business data through the subsequent selection of button 140. Selection of button 140 may be made by touching button 140 with the user's finger, if device 10 has a touch screen, or in other devices, by clicking on the button with a mouse, keyboard, keypad, trackball, etc. In another embodiment, separate buttons may be used to save the business data locally and then access the data from the local storage.

The selection of button 140 may trigger a window 150 displaying all of the available locally saved data files which may be accessed without any online connectivity. In an embodiment, all of the locally saved data files may pertain to separate files that have unique business objects and calendar interfaces. Headers for available saved data files may be displayed in selection field 160 that may be displayed in window 150. For example, in the example embodiment of FIG. 3, the available locally saved data files may include “2010 Long Term Promotions”, “2011 Short Term Promotions”, “2012 Q1 Promotions”, “2010 Short Term Promotions”, “2011 Long Term Promotions”, and “2012 Long Term Promotions”. Each of these available locally saved data files may contain their own unique calendar view and timeline interface with separate and distinct business objects which are displayed on the user interface 100.

In an embodiment, the available locally saved data files presented in window 150 may be displayed in an order in which the corresponding data file was saved. In other embodiments, the locally saved data files may be displayed based on another criteria.

A user may select a specific locally saved data file from selection field 160 to load the business data from the file into interface 100. Selection of the data file from selection field 160 may be made by touching the desired locally saved data file header with the user's finger, if device 10 has a touch screen, or in other devices, by clicking on the desired locally saved data file header with a mouse, keyboard, keypad, trackball, etc. Selection of the respective data file header may load the calendar interface for the respective locally saved date file into interface 100. A loaded locally saved data file may simply depict the calendar interface illustrated in FIG. 2. A user may have access to all of the detail information of the business objects represented by visual bars 110.1-110.n.

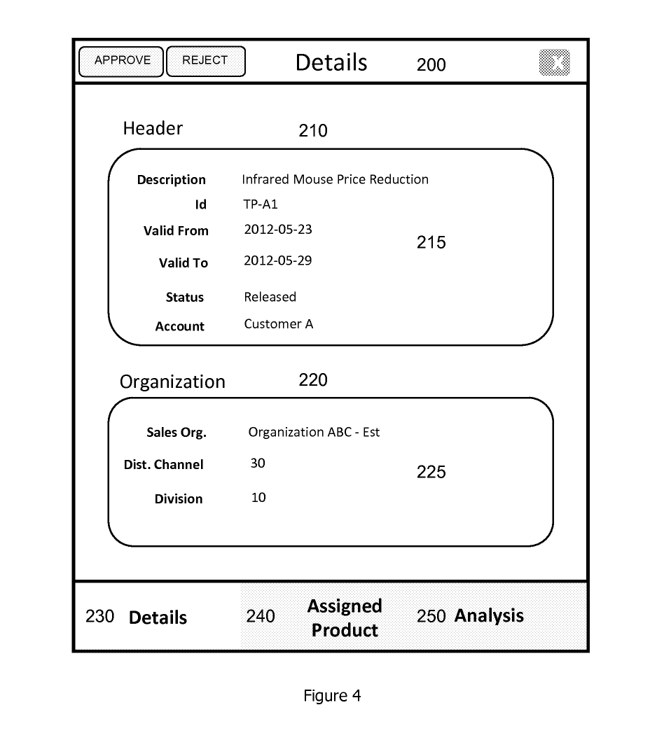

FIG. 4 illustrates detail information about a business object that is accessed in an offline mode according to an embodiment. During offline connectivity, a user may access locally saved data in device 10 that is retrieved from memory 14. This data may include, but is not limited to, timelines or charts, search or query results performed in the user interface 100, or detail information about each business object including business object attributes and corresponding analytics. FIG. 4 illustrates a modal view of detail information pertaining to a visual bar 110.1-110.n representing a particular business object that is accessed during offline connectivity. In an embodiment the displayed information may be presented in the same manner as the detailed information during online connectivity. A user may access the detail information during the offline connectivity by touching a particular visual bar 110.1-110.n presented in interface 100 with the user's finger, if device 10 has a touch screen, or in other devices, by clicking on the desired locally saved data file header with a mouse, keyboard, keypad, trackball, etc.

The detail information for a business object may be viewed during offline connectivity in a generated window 200. Window 200 may provide information corresponding to the selected business object in a “Details” section of window 200. In an embodiment, the window 200 may automatically present the “Details” section in window 200. In another embodiment, a user may navigate to the “Details” section by clicking on tab 230. Window 200 may include a first area 210 and a second area 220. In the “Details” section of window 200, the first area 210 may provide information about a business object or other business data including business object attribute values. In an embodiment where the business object is a business promotion, area 210 may provide information about the business promotion. Area 210 may include section field 215 which may provide specific information about the business object. In an embodiment where the business object is a business promotion, section field 215 may include, but is not limited to, section headers such as a description of the promotion, an identification number, a start date of the promotion, an end date of the promotion, a status of the promotion, and any corresponding customer account.

In the “Details” section of window 200, the second area 220 may provide further information about business object and its corresponding business object, specifically the business object attribute values corresponding to the internal sales organization. In an embodiment where the business object is a business promotion, area 220 may provide information about the business promotion. Area 220 may include section field 225 which may provide specific information about the business object. In an embodiment where the business object is a business promotion, section field 225 may include, but is not limited to, section headers such as the internal sales organization performing the promotion, a distribution channel, and a sales division for the promotion.

Window 200 may include tabs 240 and 250. Selection of tab 240 may provide a user with further information about a product associated with a specific business production. Selection of tab 250 may display related customized analytics to a specific business object. Selection of tabs 230, 240, and 250 may be made by touching the desired tab with the user's finger, if device 10 has a touch screen, or in other devices, by clicking on the desired tab with a mouse, keyboard, keypad, trackball, etc.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the sprit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for saving retrieved business objects locally in a calendar application, the method comprising:
retrieving the business objects and related business data stored in a backend system;
saving the business objects and the related business data in a memory housed in a mobile device; and
accessing the business objects and related business data from the memory for display in a user interface of the mobile device during offline connectivity.

2. The method according to claim 1, wherein a download of the business objects and the related business data is enabled by the triggering of the save function of the calendar application.

3. The method according to claim 1, further comprising:
loading a timeline interface including the specific accessed business objects and related business data in the user interface.

4. The method according to claim 1, further comprising:
retrieving the business objects and related business data from the memory by a processor housed in the mobile device.

5. The method according to claim 1, wherein the related business data includes business object attributes and analytics of the business objects.

6. The method according to claim 1, wherein timeline interfaces are stored in the memory.

7. The method according to claim 1, wherein search results in the calendar application performed by a search function are stored in the memory.

8. The method according to claim 1, wherein during the offline connectivity, no network connection is made to the backend system.

9. The method according to claim 2, wherein all the business objects and related business data in the calendar application are downloaded and stored in the memory.

10. The method according to claim 2, wherein only a subset business objects and related business data pertaining to a particular timeline interface are downloaded and stored in the memory.

11. A mobile device having a calendar application stored thereon to save retrieved business objects locally in application, the mobile device comprising:
a user interface displayed on a screen;
a memory;
an arrangement performing the following:
retrieving the business objects and related business data stored in a backend system;
saving the business objects and the related business data in a memory housed in a mobile device; and
accessing the business objects and related business data from the memory for display in the user interface during offline connectivity.

12. The mobile device according to claim 11, wherein a download of the business objects and the related business data is enabled by the triggering of the save function of the calendar application.

13. The mobile device according to claim 11, wherein a timeline interface including the specific accessed business objects and related business data is loaded in the user interface.

14. The mobile device according to claim 11, further comprising:
a processor to retrieve the business objects and related business data from the memory.

15. The mobile device according to claim 11, wherein the related business data includes at least one of business object attributes, analytics of the business objects, and search results in the calendar application performed by a search function.

16. The mobile device according to claim 11, wherein during the offline connectivity, no network connection is made to the backend system.

17. The mobile device according to claim 12, wherein all the business objects and related business data in the calendar application are downloaded and stored in the memory.

18. The mobile device according to claim 12, wherein only a subset business objects and related business data pertaining to a particular timeline interface are downloaded and stored in the memory.

19. An apparatus for saving retrieved business objects locally in a calendar application, the apparatus comprising:
a mobile device housing a processor and a memory; and
the calendar application displayed on a user interface of the mobile device, the calendar application being executed to:
retrieve the business objects and related business data stored in a backend system;
save the business objects and the related business data in the memory, wherein a save function triggers a download of the business objects and the related business data into the memory;
access the business objects and related business data from the memory for display in the user interface during offline connectivity, retrieval of the business objects and related business data from the memory being done by the processor;
and
load a timeline interface including the specific accessed business objects and related business data in the user interface for display.

20. A system for saving retrieved business objects locally in a calendar application, the system comprising:
at least one backend server storing business objects;
a mobile device housing a memory and a processor, the mobile device executing an application for display on an interface of the mobile device, the application executed to:
retrieve the business objects and related business data stored in the at least one backend server;
save the business objects and the related business data in the memory, wherein a save function triggers a download of the business objects and the related business data into the memory;
access the business objects and related business data from the memory for display in the user interface during offline connectivity where no connection is made to the at least one backend server, retrieval of the business objects and related business data from the memory being done by the processor; and
load a timeline interface including the specific accessed business objects and related business data in the user interface for display.
